(19) United States
(12) Patent Application Publication
(10) Pub. No.: US 2022/0269786 A1
(43) Pub. Date: Aug. 25, 2022

(54) INFORMATION PROCESSING APPARATUS, INFORMATION PROCESSING SYSTEM, INFORMATION PROCESSING METHOD, AND COMPUTER-READABLE MEDIUM

(71) Applicant: NEC Corporation, Minato-ku, Tokyo (JP)

(72) Inventor: Satoshi IKEDA, Tokyo (JP)

(73) Assignee: NEC Corporation, Minato-ku, Tokyo (JP)

(21) Appl. No.: 17/632,839

(22) PCT Filed: Aug. 9, 2019
(86) PCT No.: PCT/JP2019/031643

§ 371 Date: Feb. 4, 2022

(51) Int. Cl. G06F 21/56; G06F 16/901; G06F 16/903

(52) U.S. Cl. CPC G06F 21/566; G06F 16/9024; G06F 16/90335; G06F 2221/034

(57) ABSTRACT

An information processing apparatus (10) according to an aspect of the present invention includes a similarity determination unit (13) configured to determine a degree of similarity between first and second queries used for detection of behavior of malware, and an integration unit (14) configured to perform integration of the first and second queries according to a determination result from the similarity determination unit (13). The similarity determination unit (13) determines the degree of similarity between the first and second queries by using a first graph structure corresponding to the first query and a second graph structure corresponding to the second query. The integration unit (14) performs integration of the first and second queries by extracting a common part between the first graph structure and the second graph structure.

### TECHNICAL FIELD

The present invention relates to an information processing apparatus, an information processing system, an information processing method and a computer-readable medium, and more particularly, to an information processing apparatus, an information processing system, an information processing method and a computer-readable medium used for threat hunting for malware and the like.

### BACKGROUND ART

These days, threat hunting for finding threats such as malware already lurking in an organization is becoming more and more important. A technology for detecting pieces of malware of new variants and sub-variants that are missed by existing security apparatuses is becoming important.

Patent Literature 1 discloses a technology related to a threat detection program for detecting unknown malware as a threat.

### CITATION LIST

### Patent Literature

Patent Literature 1: Japanese Unexamined Patent Application Publication No. 2018-200642

### SUMMARY OF INVENTION

### Technical Problem

As a method of threat hunting, there is a technology of extracting a malware signature (Indicators of Compromise: IoC) from a dynamic analysis result for malware, and of detecting malware using the extracted signature information (see Patent Literature 1). With this technology, a query (a search condition) is created using the dynamic analysis result for malware. An abnormal operation caused by malware is detected using the created query.

However, when there are numerous dynamic analysis results for malware, the number of queries created using the dynamic analysis results is also great. When the number of queries is great, there is a problem that management of the queries becomes burdensome.

In view of the problem described above, the present invention is aimed at providing an information processing apparatus, an information processing system, an information processing method and a computer-readable medium that enable easy management of queries used for detection of behavior of malware.

### Solution to Problem

An information processing apparatus according to an aspect of the present invention includes a similarity determination unit configured to determine a degree of similarity between first and second queries used for detection of behavior of malware; and an integration unit configured to perform integration of the first and second queries according to a determination result from the similarity determination unit. The similarity determination unit determines the degree of similarity between the first and second queries by using a first graph structure corresponding to the first query and a second graph structure corresponding to the second query. The integration unit performs integration of the first and second queries by extracting a common part between the first graph structure and the second graph structure.

An information processing system according to an aspect of the present invention includes the information processing apparatus described above; and a search apparatus configured to search for event information that matches a query that is supplied from the information processing apparatus, from event information collected from a terminal.

An information processing method according to an aspect of the present invention includes determining a degree of similarity between first and second queries used for detection of behavior of malware; and integrating the first and second queries according to a result of the determining. At a time of determining the degree of similarity, the degree of similarity between the first and second queries is determined by using a first graph structure corresponding to the first query and a second graph structure corresponding to the second query. At a time of integrating the first and second queries, the first and second queries are integrated by extracting a common part between the first graph structure and the second graph structure.

A computer-readable medium according to an aspect of the present invention is a non-transitory computer-readable medium storing a program for causing a computer to perform processes including determining a degree of similarity between first and second queries used for detection of behavior of malware, integrating the first and second queries according to a result of the determining, determining the degree of similarity between the first and second queries by using a first graph structure corresponding to the first query and a second graph structure corresponding to the second query, at a time of determining the degree of similarity, and integrating the first and second queries by extracting a common part between the first graph structure and the second graph structure, at a time of integrating the first and second queries.

### Advantageous Effects of Invention

According to the present invention, there can be provided an information processing apparatus, an information processing system, an information processing method and a computer-readable medium that enable easy management of queries used for detection of behavior of malware.

### BRIEF DESCRIPTION OF THE DRAWINGS

FIG. 1 is a block diagram for describing an information processing apparatus according to an example embodiment;

FIG. 2 is a block diagram for describing a detailed configuration of the information processing apparatus according to the example embodiment;

FIG. 3 shows tables indicating an example of a query Q1;

FIG. 4 shows tables indicating an example of a query Q2;

FIG. 5 is a diagram showing an example of a graph structure corresponding to the query Q1;

FIG. 6 is a diagram showing an example of a graph structure corresponding to the query Q2;

FIG. 7 is a diagram showing an example of a graph structure (corresponding to a query QM) of common parts of the graph structure of the query Q1 and the graph structure of the query Q2;

FIG. 8 shows tables indicating the query QM obtained by integration;

FIG. 9 is a flowchart for describing an example of an operation of the information processing apparatus according to the example embodiment;

FIG. 10 is a diagram for describing an example of a calculation method for a similarity score;

FIG. 11 is a diagram for describing an example of the calculation method for the similarity score;

FIG. 12 shows tables each indicating an example of a query Q3, Q4;

FIG. 13 is a diagram for describing another example of an integration process;

FIG. 14 is a table showing the query QM obtained by integration;

FIG. 15 is a diagram for describing an example of the calculation method for the similarity score;

FIG. 16 is a block diagram for describing an information processing system including the information processing apparatus according to the example embodiment; and

FIG. 17 is a block diagram showing a computer for executing an information processing program according to the present invention.

### DESCRIPTION OF EMBODIMENTS

Hereinafter, an example embodiment of the present invention will be described with reference to the drawings.

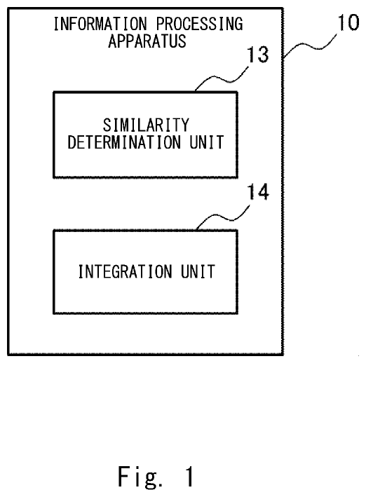

First, an outline of the present invention will be given. FIG. 1 is a block diagram for describing an information processing apparatus according to a first example embodiment, and is a block diagram for giving an outline of the present invention.

As shown in FIG. 1, an information processing apparatus 10 according to a present example embodiment includes a similarity determination unit 13 and an integration unit 14. The similarity determination unit 13 determines a degree of similarity between first and second queries used for detection of behavior of malware. Here, the similarity determination unit 13 determines the degree of similarity between the first and second queries using a first graph structure corresponding to the first query and a second graph structure corresponding to the second query. The integration unit 14 integrates the first and second queries according to a determination result from the similarity determination unit 13. Here, the integration unit 14 integrates the first and second queries by extracting common parts between the first graph structure and the second graph structure.

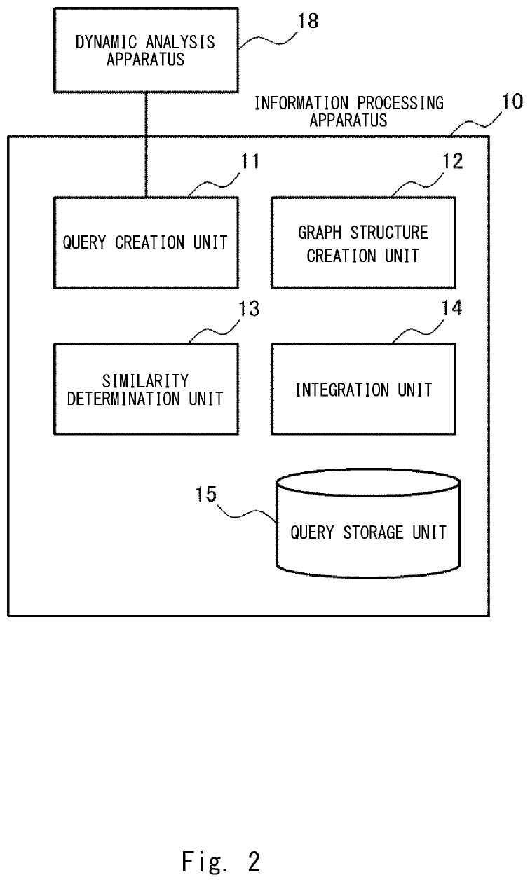

In the invention according to the present example embodiment having the configuration as described above, the degree of similarity between the first and second queries is determined, and the first and second queries are integrated according to the determination result. That is, the information processing apparatus according to the present example embodiment integrates the first and second queries in a case where the first and second queries are determined to be similar to each other. Accordingly, even in a case where a large number of queries are created using dynamic analysis results, queries that are similar to each other may be integrated, and the number of queries to be managed (that is, the number of queries to be stored in a query storage unit shown in FIG. 2) may thus be reduced. Accordingly, management of queries used for detection of behavior of malware may be facilitated. “Management of queries” here refers to presentation of a query to a user, deletion of an unnecessary query based on an instruction from the user, and the like. In the following, details of the present invention will be given.

FIG. 2 is a block diagram for describing a detailed configuration of the information processing apparatus according to the present example embodiment. As shown in FIG. 2, the information processing apparatus 10 according to the present example embodiment includes a query creation unit 11, a graph structure creation unit 12, the similarity determination unit 13, the integration unit 14, and a query storage unit 15. A dynamic analysis apparatus 18 is connected to the query creation unit 11.

The dynamic analysis apparatus 18 is an apparatus that dynamically analyzes a behavior of malware using a malware sample. Specifically, the dynamic analysis apparatus 18 creates a dynamic analysis result based on an event occurring during operation of malware. The dynamic analysis result created by the dynamic analysis apparatus 18 is supplied to the query creation unit 11.

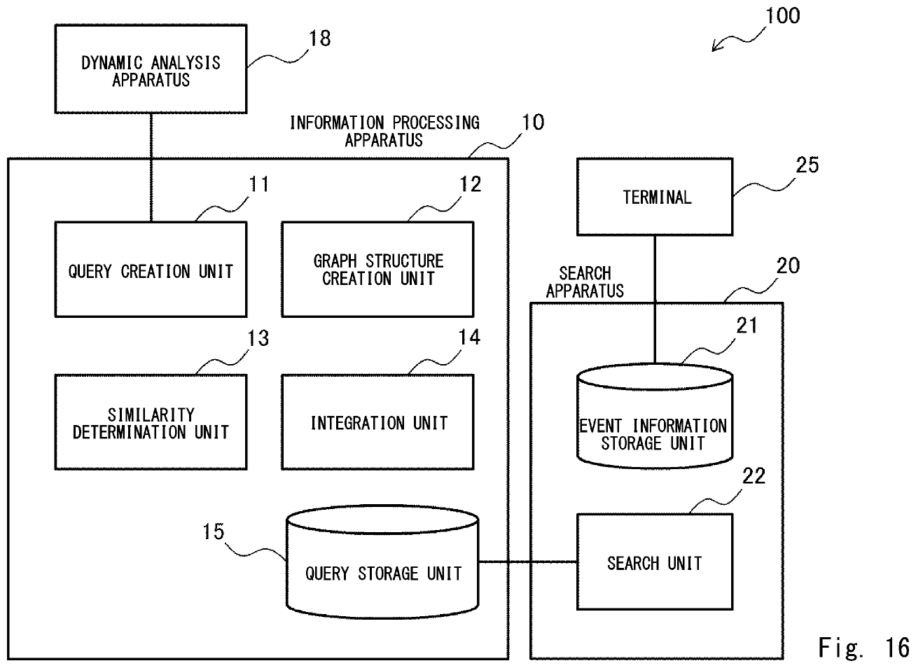

The query creation unit 11 creates a query using the dynamic analysis result supplied from the dynamic analysis apparatus 18. This query is a search condition used for detection of behavior of malware. For example, a terminal where malware is operating may be identified by collecting pieces of event information from a predetermined terminal and by searching for event information that matches the query from the pieces of event information. Additionally, detection of behavior of malware using the query will be described later (see FIG. 16).

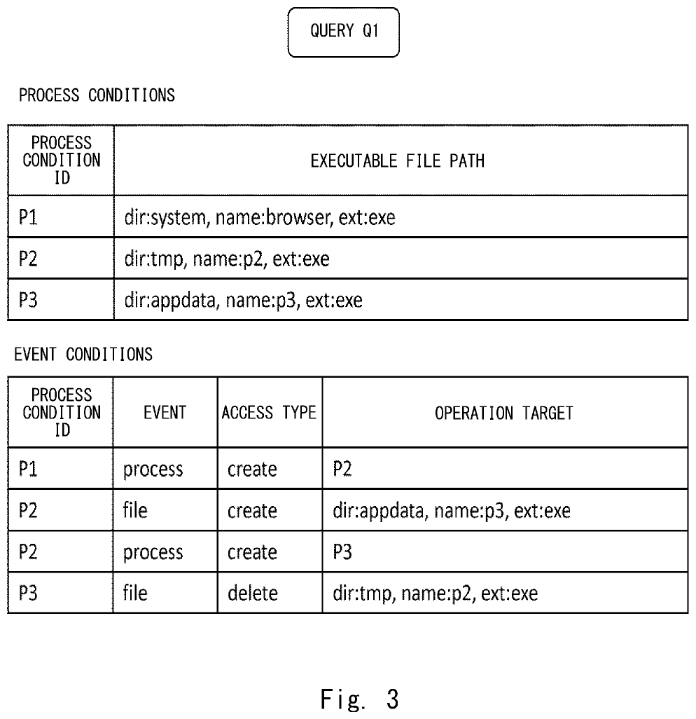

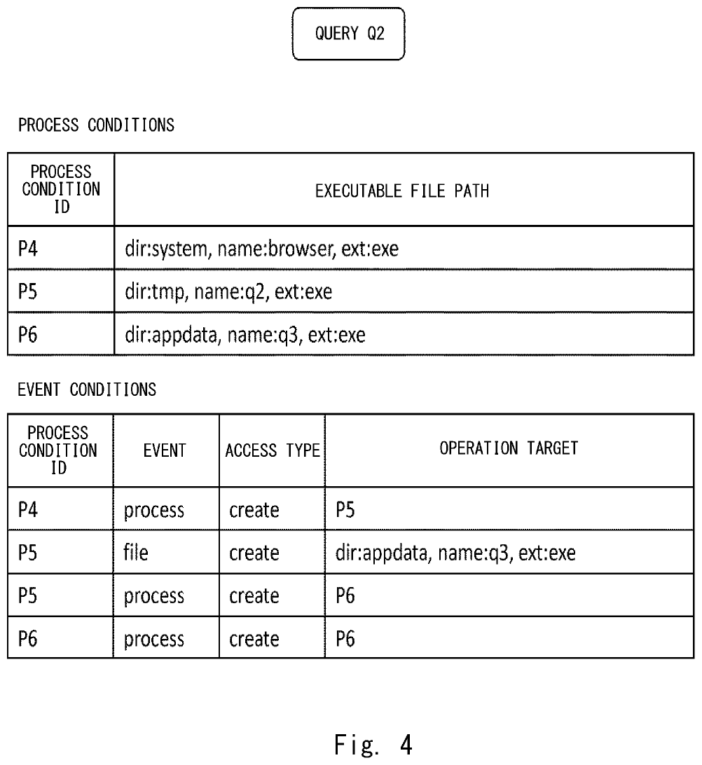

FIGS. 3 and 4 each show tables indicating an example of a query that is created by the query creation unit 11. FIG. 3 shows an example of a query Q1, and FIG. 4 shows an example of a query Q2. The tables shown in FIG. 3 indicate process conditions and event conditions for the query Q1.

The table for the process conditions shown in FIG. 3 includes a process condition ID and an executable file path. For example, with respect to the first row in the table for the process conditions, the process condition ID is “P1”, and the executable file path is {dir:system, name:browser, ext:exe}. Additionally, “dir”, “name”, and “ext” each indicate a directory path, a file name excluding an extension, and the extension, and {dir:system, name:browser, ext:exe} indicates a condition matching a file path “/system/browser.exe”. With respect to the second row in the table for the process conditions, the process condition ID is “P2”, and the executable file path is {dir:tmp, name:p2, ext:exe}. With respect to the third row in the table for the process conditions, the process condition ID is “P3”, and the executable file path is {dir:appdata, name:p3, ext:exe}.

Furthermore, the table for the event conditions shown in FIG. 3 includes a process condition ID, an event, an access type, and an operation target. Additionally, the process condition ID of the event conditions is for identifying an entry of the process conditions.

For example, with respect to the first row in the table for the event conditions, the process condition ID is “P1”, the event is “process”, the access type is “create”, and the operation target is “P2”. This means that the process “P2” is created by the process “P1”. With respect to the second row in the table for the event conditions, the process condition ID is “P2”, the event is “file”, the access type is “create”, and the operation target is {dir:appdata, name:p3, ext:exe}. This means that “file” whose file path matches {dir:appdata, name:p3, ext:exe} is created by the process “P2”. Furthermore, with respect to the third row in the table for the event conditions, the process condition ID is “P2”, the event is “process”, the access type is “create”, and the operation target is “P3”. This means that the process “P3” is created by the process “P2”. With respect to the fourth row in the table for the event conditions, the process condition ID is “P3”, the event is “file”, the access type is “delete”, and the operation target is {dir:tmp, name:p2, ext:exe}. This means that “file” whose file path matches {dir:tmp, name:p2, ext:exe} is deleted by the process “P3”.

Additionally, basically the same thing can be said for the query Q2 shown in FIG. 4 as for the query Q1 shown in FIG. 3 described above, and redundant description is omitted.

Furthermore, in the present specification, data is expressed in the form of {a:1, b:2}, and such a description indicates that values in fields a and b are 1 and 2, respectively. Furthermore, a list structure is expressed in the form of [a, b, c], and this case indicates a list including three elements a, b and c.

The graph structure creation unit 12 shown in FIG. 2 creates graph structures of the queries Q1, Q2 by expressing each of the queries Q1, Q2 as a directed graph. In other words, the graph structure creation unit 12 creates the graph structures of the queries Q1, Q2 by performing a graph structure creation process on the queries Q1, Q2 created by the query creation unit 11 (queries may alternatively be those stored in the query storage unit 15). The graph structure here expresses a structure of a query by a set of nodes and edges.

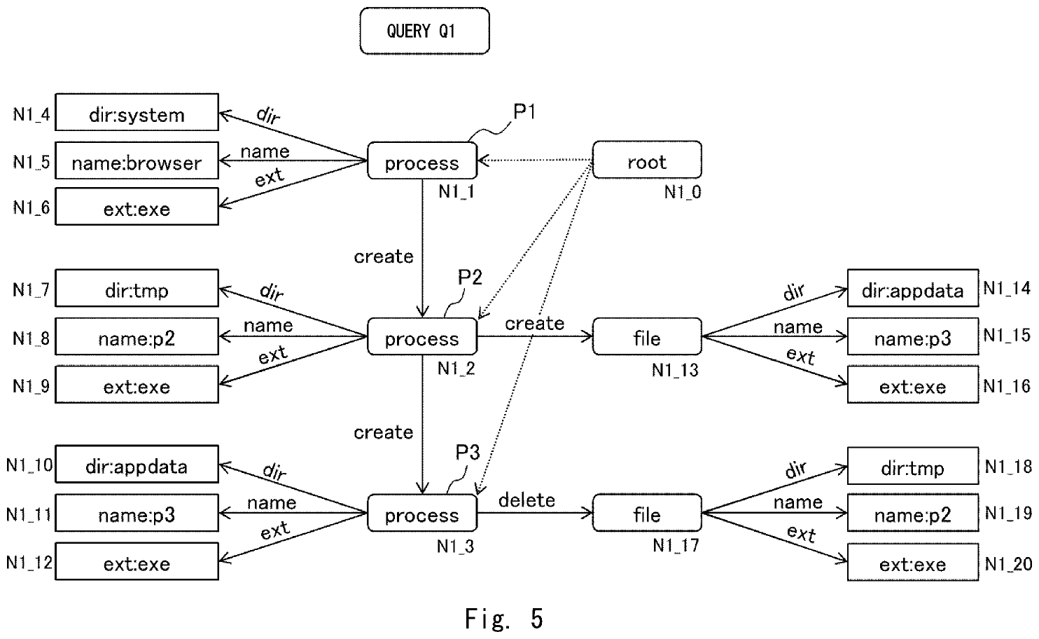

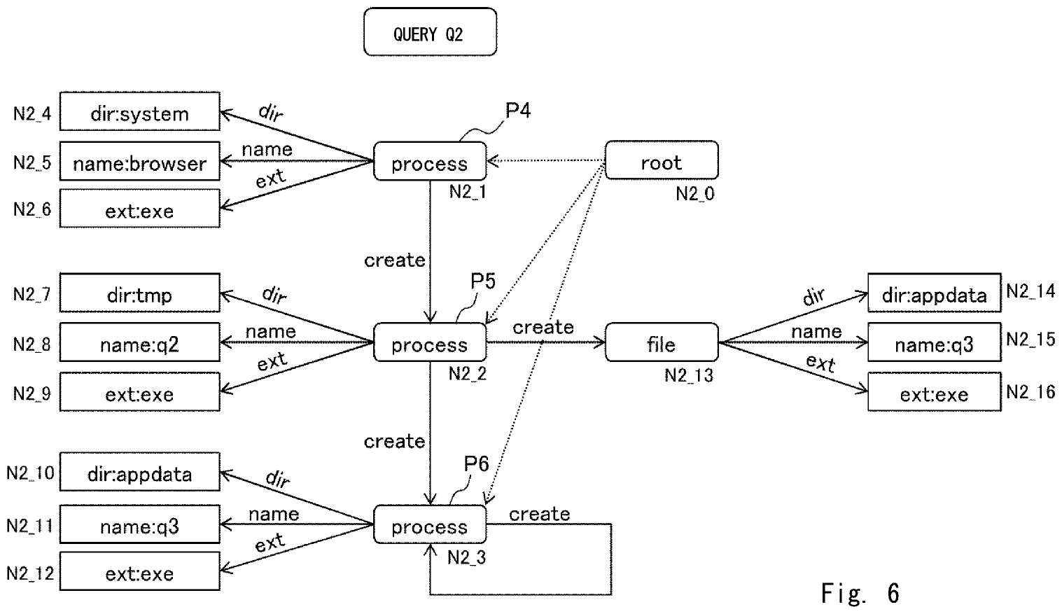

FIGS. 5 and 6 are each a diagram showing an example of the graph structure corresponding to the query Q1, Q2. FIG. 5 shows the graph structure that is created based on the query Q1 shown in FIG. 3. FIG. 6 shows the graph structure that is created based on the query Q2 shown in FIG. 4. In the following, the graph structures shown in FIGS. 5 and 6 will be described.

The graph structure shown in FIG. 5 is a graph structure that is created based on the query Q1 shown in FIG. 3. A node N1_1 in the graph structure shown in FIG. 5 corresponds to a node whose process condition ID in FIG. 3 is “P1”. Furthermore, nodes N1_4, N1_5, and N1_6 in the graph structure shown in FIG. 5 correspond, respectively, to the executable file paths “dir:system”, “name:browser”, and “ext:exe” associated with the process condition ID “P1” in the table for the process conditions in FIG. 3. Arrows, shown in FIG. 5, extending from the node N1_1 to the nodes N1_4, N1_5, and N1_6 each indicate an edge, and labels of the edges are “dir”, “name”, and “ext”, respectively.

A node N1_2 in the graph structure shown in FIG. 5 corresponds to a node whose process condition ID in FIG. 3 is “P2”. Here, an arrow extending from the node N1_1 to the node N1_2 is an edge labeled “create”, and corresponds to the first row (creation of the process “P2” by the process “P1”) in the table for the event conditions in FIG. 3. Furthermore, nodes N1_7, N1_8, and N1_9 in the graph structure shown in FIG. 5 correspond, respectively, to the executable file paths “dir:tmp”, “name:p2”, and “ext:exe” associated with the process condition ID “P2” in the table for the process conditions in FIG. 3. Arrows, shown in FIG. 5, extending from the node N1_2 to the nodes N1_7, N1_8, and N1_9 each indicate an edge, and labels of the edges are “dir”, “name”, and “ext”, respectively.

An arrow extending from the node N1_2 to a node N1_13 is an edge labeled “create”, and corresponds to the second row (creation of “file” by the process “P2”) in the table for the event conditions in FIG. 3. Furthermore, nodes N1_14, N1_15, and N1_16 in the graph structure shown in FIG. 5 correspond, respectively, to the operation targets “dir:appdata”, “name:p3”, and “ext:exe” in the second row in the table for the event conditions in FIG. 3. Arrows, shown in FIG. 5, extending from the node N1_13 to the nodes N1_14, N1_15, and N1_16 each indicate an edge, and labels of the edges are “dir”, “name”, and “ext”, respectively.

A node N1_3 in the graph structure shown in FIG. 5 corresponds to a node whose process condition ID in FIG. 3 is “P3”. Here, an arrow extending from the node N1_2 to the node N1_3 is an edge labeled “create”, and corresponds to the third row (creation of the process “P3” by the process “P2”) in the table for the event conditions in FIG. 3. Furthermore, nodes N1_10, N1_11, and N1_12 in the graph structure shown in FIG. 5 correspond, respectively, to the executable file paths “dir:appdata”, “name:p3”, and “ext:exe” associated with the process condition ID “P3” in the table for the process conditions in FIG. 3. Arrows, shown in FIG. 5, extending from the node N1_3 to the nodes N1_10, N1_11, and N1_12 each indicate an edge, and labels of the edges are “dir”, “name”, and “ext”, respectively.

An arrow extending from the node N1_3 to a node N1_17 is an edge labeled “delete”, and corresponds to the fourth row (deletion of “file” by the process “P3”) in the table for the event conditions in FIG. 3. Furthermore, nodes N1_18, N1_19, and N1_20 in the graph structure shown in FIG. 5 correspond, respectively, to the operation targets “dir:tmp”, “name:p2”, and “ext:exe” in the fourth row in the table for the event conditions in FIG. 3. Arrows, shown in FIG. 5, extending from the node N1_17 to the nodes N1_18, N1_19, and N1_20 each indicate an edge, and labels of the edges are “dir”, “name”, and “ext”, respectively.

Moreover, a root node N1_0 is connected to each of the nodes N1_1, N1_2, and N1_3 corresponding to processes. The root node N1_0 is a node provided for the sake of convenience to grasp a relationship between the nodes N1_1, N1_2, and N1_3 even in a case where the N1_1, N1_2, and N1_3 corresponding to processes are separated from one another (that is, not connected by edges).

Next, the graph structure shown in FIG. 6 will be described. The graph structure shown in FIG. 6 is a graph structure that is created based on the query Q2 shown in FIG. 4. A node N2_1 in the graph structure shown in FIG. 6 corresponds to a node whose process condition ID in FIG. 4 is “P4”. Furthermore, nodes N2_4, N2_5, and N2_6 in the graph structure shown in FIG. 6 correspond, respectively, to the executable file paths “dir:system”, “name:browser”, and “ext:exe” associated with the process condition ID “P4” in the table for the process conditions in FIG. 4. Arrows, shown in FIG. 6, extending from the node N2_1 to the nodes N2_4, N2_5, and N2_6 each indicate an edge, and labels of the edges are “dir”, “name”, and “ext”, respectively.

A node N2_2 in the graph structure shown in FIG. 6 corresponds to a node whose process condition ID in FIG. 4 is “P5”. Here, an arrow extending from the node N2_1 to the node N2_2 is an edge labeled “create”, and corresponds to the first row (creation of the process “P5” by the process “P4”) in the table for the event conditions in FIG. 4. Furthermore, nodes N2_7, N2_8, and N2_9 in the graph structure shown in FIG. 6 correspond, respectively, to the executable file paths “dir:tmp”, “name:q2”, and “ext:exe” associated with the process condition ID “P5” in the table for the process conditions in FIG. 4. Arrows, shown in FIG. 6, extending from the node N2_2 to the nodes N2_7, N2_8, and N2_9 each indicate an edge, and labels of the edges are “dir”, “name”, and “ext”, respectively.

An arrow extending from the node N2_2 to a node N2_13 is an edge labeled “create”, and corresponds to the second row (creation of “file” by the process “P5”) in the table for the event conditions in FIG. 4. Furthermore, nodes N2_14, N2_15, and N2_16 in the graph structure shown in FIG. 6 correspond, respectively, to the operation targets “dir:appdata”, “name:q3”, and “ext:exe” in the second row in the table for the event conditions in FIG. 4. Arrows, shown in FIG. 6, extending from the node N2_13 to the nodes N2_14, N2_15, and N2_16 each indicate an edge, and labels of the edges are “dir”, “name”, and “ext”, respectively.

A node N2_3 in the graph structure shown in FIG. 6 corresponds to a node whose process condition ID in FIG. 4 is “P6”. Here, an arrow extending from the node N2_2 to the node N2_3 is an edge labeled “create”, and corresponds to the third row (creation of the process “P6” by the process “P5”) in the table for the event conditions in FIG. 4. Furthermore, nodes N2_10, N2_11, and N2_12 in the graph structure shown in FIG. 6 correspond, respectively, to the executable file paths “dir:appdata”, “name:q3”, and “ext:exe” associated with the process condition ID “P6” in the table for the process conditions in FIG. 4. Arrows, shown in FIG. 6, extending from the node N2_3 to the nodes N2_10, N2_11, and N2_12 each indicate an edge, and labels of the edges are “dir”, “name”, and “ext”, respectively.

Moreover, an arrow forming a loop from the node N2_3 to the node N2_3 is an edge labeled “create”, and corresponds to the fourth row (creation of the process “P6” by the process “P6”) in the table for the event conditions in FIG. 4.

Moreover, a root node N2_0 is connected to each of the nodes N2_1, N2_2, and N2_3 corresponding to processes. The root node N2_0 is a node provided for the sake of convenience to grasp a relationship between the nodes N2_1, N2_2, and N2_3 even in a case where the N2_1, N2_2, and N2_3 corresponding to processes are separated from one another (that is, not connected by edges).

The graph structure creation unit 12 may create the graph structures of the queries Q1, Q2 by performing the graph structure creation process as described above on the queries Q1, Q2. Additionally, the graph structure creation process described above is merely an example, and the information processing apparatus according to the present example embodiment may perform the graph structure creation process using methods other than the one described above.

The similarity determination unit 13 shown in FIG. 2 determines the degree of similarity between the query Q1 and the query Q2. Specifically, the similarity determination unit 13 determines the degree of similarity between the query Q1 and the query Q2 by using the graph structure of the query Q1 and the graph structure of the query Q2 created by the graph structure creation unit 12. For example, the similarity determination unit 13 may calculate a similarity score for the query Q1 and the query Q2 by associating at least the nodes or the edges in the graph structure of the query Q1 with at least the nodes or the edges in the graph structure of the query Q2.

That is, the similarity determination unit 13 may calculate the similarity score for the query Q1 and the query Q2 by associating the nodes in the graph structure of the query Q1 with the nodes in the graph structure of the query Q2. Furthermore, the similarity determination unit 13 may calculate the similarity score for the query Q1 and the query Q2 by associating the edges in the graph structure of the query Q1 with the edges in the graph structure of the query Q2. Moreover, the similarity determination unit 13 may calculate the similarity score for the query Q1 and the query Q2 by associating each of the nodes and the edges in the graph structure of the query Q1 with each of the nodes and the edges in the graph structure of the query Q2.

The similarity determination unit 13 may determine that the query Q1 and the query Q2 are similar to each other, in a case where the calculated similarity score is equal to or greater than a predetermined threshold. Additionally, details of similarity determination by the similarity determination unit 13 will be given later.

The integration unit 14 integrates the query Q1 and the query Q2 according to a determination result from the similarity determination unit 13. Specifically, the integration unit 14 integrates the query Q1 and the query Q2 in a case where the query Q1 and the query Q2 are determined by the similarity determination unit 13 to be similar to each other. For example, the integration unit 14 may integrate the query Q1 and the query Q2 by extracting common parts (a common sub-graph) between the graph structure corresponding to the query Q1 and the graph structure corresponding to the query Q2.

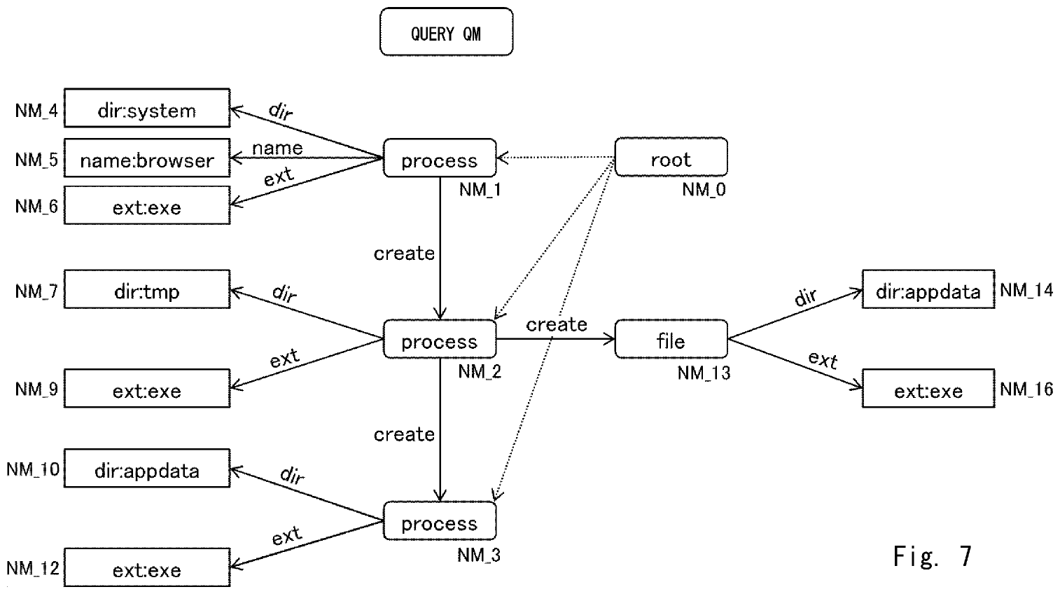

FIG. 7 is a diagram for describing an example of an integration process by the integration unit 14, and is a diagram showing an example of a graph structure (corresponding to a query QM) of common parts between the graph structure of the query Q1 and the graph structure of the query Q2. Additionally, the common sub-graph structure shown in FIG. 7 may also be used for similarity determination by the similarity determination unit 13 described later.

In the graph structure shown in FIG. 7, a node NM_1 corresponds to the node N1_1 in the graph structure in FIG. 5, and to the node N2_1 in the graph structure in FIG. 6. Nodes NM_4, NM_5, and NM_6 in FIG. 7 correspond to the nodes N1_4, N1_5, and N1_6 in FIG. 5, respectively, and to the nodes N2_4, N2_5, and N2_6 in FIG. 6, respectively. Edges, in FIG. 7, extending from the node NM_1 to the nodes NM_4, NM_5, and NM_6 correspond to the edges, in FIG. 5, extending from the node N1_1 to the nodes N1_4, N1_5, and N1_6, respectively, and to the edges, in FIG. 6, extending from the node N2_1 to the nodes N2_4, N2_5, and N2_6, respectively.

A node NM_2 in FIG. 7 corresponds to the node N1_2 in FIG. 5, and to the node N2_2 in FIG. 6. An edge, in FIG. 7, extending from the node NM_1 to the node NM_2 corresponds to the edge, in FIG. 5, extending from the node N1_1 to the node N1_2, and to the edge, in FIG. 6, extending from the node N2_1 to the node N2_2. Nodes NM_7 and NM_9 in FIG. 7 correspond to the nodes N1_7 and N1_9 in FIG. 5, respectively, and to the nodes N2_7 and N2_9 in FIG. 6, respectively. Edges, in FIG. 7, extending from the node NM_2 to the nodes NM_7 and NM_9 correspond to the edges, in FIG. 5, extending from the node N1_2 to the nodes N1_7 and N1_9, respectively, and to the edges, in FIG. 6, extending from the node N2_2 to the nodes N2_7 and N2_9, respectively. Here, a label of the node N1_8 in FIG. 5 is “name:p2”, and a label of the node N2_8 in FIG. 6 is “name:q2”, and the two are different from each other. Accordingly, nodes corresponding to these nodes are deleted in FIG. 7.

A node NM_13 in FIG. 7 corresponds to the node N1_13 in FIG. 5, and to the node N2_13 in FIG. 6. Nodes NM_14 and NM_16 in FIG. 7 correspond to the nodes N1_14 and N1_16 in FIG. 5, respectively, and to the nodes N2_14 and N2_16 in FIG. 6, respectively. Edges, in FIG. 7, extending from the node NM_13 to the nodes NM_14 and NM_16 correspond to the edges, in FIG. 5, extending from the node N1_13 to the nodes N1_14 and N1_16, respectively, and to the edges, in FIG. 6, extending from the node N2_13 to the nodes N2_14 and N2_16, respectively. Here, a label of the node N1_15 in FIG. 5 is “name:p3”, and a label of the node N2_15 in FIG. 6 is “name:q3”, and the two are different from each other. Accordingly, nodes corresponding to these nodes are deleted in FIG. 7.

A node NM_3 in FIG. 7 corresponds to the node N1_3 in FIG. 5, and to the node N2_3 in FIG. 6. An edge, in FIG. 7, extending from the node NM_2 to the node NM_3 corresponds to the edge, in FIG. 5, extending from the node N1_2 to the N1_3, and to the edge, in FIG. 6, extending from the node N2_2 to the node N2_3. Nodes NM_10 and NM_12 in FIG. 7 correspond to the nodes N1_10 and N1_12 in FIG. 5, respectively, and to the nodes N2_10 and N2_12 in FIG. 6, respectively. Edges, in FIG. 7, extending from the node NM_3 to the nodes NM_10 and NM_12 correspond to the edges, in FIG. 5, extending from the node N1_3 to the nodes N1_10 and N1_12, respectively, and to the edges, in FIG. 6, extending from the node N2_3 to the nodes N2_10 and N2_12, respectively. Here, a label of the node N1_11 in FIG. 5 is “name:p3”, and a label of the node N2_11 in FIG. 6 is “name:q3”, and the two are different from each other. Accordingly, nodes corresponding to these nodes are deleted in FIG. 7. Furthermore, in FIG. 7, nodes corresponding to the nodes N1_17, N1_18, N1_19, and N1_20 in FIG. 5 are deleted.

As described above, the integration unit 14 may create a graph structure as shown in FIG. 7 by extracting common parts between the graph structure corresponding to the query Q1 and the graph structure corresponding to the query Q2. Then, the integration unit 14 may create the query QM integrating the query Q1 and the query Q2, by using the extracted graph structure.

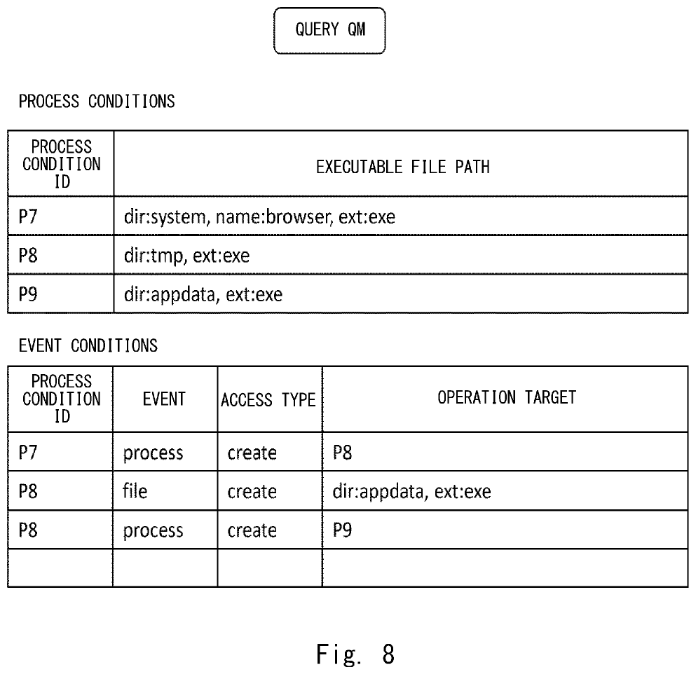

FIG. 8 shows tables indicating the query QM obtained by integration, the tables indicating a query that is created using the graph structure shown in FIG. 7 (that is, the query QM obtained by integration). The tables shown in FIG. 8 indicate the process conditions and the event conditions for the query QM obtained by integration. Additionally, at the time of extracting the common parts, a graph structure including a structure that cannot be expressed as a query, such as an event condition with no edge from a “process” node, is possibly extracted, for example. In this case, to obtain a query expression from the graph structure, a node that cannot be reached from the root node may be removed.

The table for the process conditions shown in FIG. 8 include the process condition ID and the executable file path. With respect to the first row in the table for the process conditions, the process condition ID is “P7”, and the executable file path is {dir:system, name:browser, ext:exe}. This corresponds to a common part between the process condition ID “P1” in the query Q1 shown in FIG. 3 and the process condition ID “P4” in the query Q2 shown in FIG. 4. With respect to the second row in the table for the process conditions shown in FIG. 8, the process condition ID is “P8”, and the executable file path is {dir:tmp, ext:exe}. This corresponds to a common part between the process condition ID “P2” in the table for the process conditions for the query Q1 shown in FIG. 3 and the process condition ID “P5” in the table for the process conditions for the query Q2 shown in FIG. 4. With respect to the third row in the table for the process conditions shown in FIG. 8, the process condition ID is “P9”, and the executable file path is {dir:appdata, ext:exe}. This corresponds to a common part between the process condition ID “P3” in the table for the process conditions for the query Q1 shown in FIG. 3 and the process condition ID “P6” in the table for the process conditions for the query Q2 shown in FIG. 4.

Furthermore, with respect to the first row in the table for the event conditions shown in FIG. 8, the process condition ID is “P7”, the event is “process”, the access type is “create”, and the operation target is “P8”. This corresponds to a common part between the first row in the table for the event conditions shown in FIG. 3 and the first row in the table for the event conditions shown in FIG. 4. With respect to the second row in the table for the event conditions shown in FIG. 8, the process condition ID is “P8”, the event is “file”, the access type is “create”, and the operation target is {dir:appdata, ext:exe}. This corresponds to a common part between the second row in the table for the event conditions shown in FIG. 3 and the second row in the table for the event conditions shown in FIG. 4. Moreover, with respect to the third row in the table for the event conditions shown in FIG. 8, the process condition ID is “P8”, the event is “process”, the access type is “create”, and the operation target is “P9”. This corresponds to a common part between the third row in the table for the event conditions shown in FIG. 3 and the third row in the table for the event conditions shown in FIG. 4.

The integration unit 14 may create the query QM integrating the query Q1 and the query Q2 by performing the process as described above.

The query storage unit 15 shown in FIG. 2 stores the query created by the query creation unit 11, and the query obtained by integration by the integration unit 14.

As described above, with the invention according to the present example embodiment, the degree of similarity between the query Q1 and the query Q2 is determined, and the query Q1 and the query Q2 are integrated according to the determination result. That is, the information processing apparatus according to the present example embodiment integrates the query Q1 and the query Q2 in a case where the query Q1 and the query Q2 are determined to be similar to each other. Accordingly, even in a case where the number of queries created using the dynamic analysis results is great, queries that are similar to each other may be integrated, and the number of queries to be managed (that is, the number of queries to be stored in the query storage unit 15) may be reduced. Management of queries to be used for detection of behavior of malware may thus be facilitated.

Particularly, in the case where malware samples as analysis targets of the dynamic analysis apparatus 18 are spreading malware samples of the same type, the number of queries that are created by the query creation unit 11 becomes great. With the invention according to the present example embodiment, queries that are similar to each other are integrated as described above, and thus, even in a case where a large number of queries are created by the query creation unit 11, the number of such queries may be effectively reduced.

For example, with the information processing apparatus according to the present example embodiment, when a new query is created by the query creation unit 11, the similarity determination unit 13 determines the degree of similarity between the query supplied from the query creation unit 11 and a query that is stored in advance in the query storage unit 15. Then, in the case where the queries are determined to be similar to each other, the integration unit 14 may integrate the queries, and may rewrite the query that is stored in the query storage unit 15 with the query obtained by integration.

For example, with the information processing apparatus according to the present example embodiment, a plurality of queries are stored in the query storage unit 15, and the similarity determination unit 13 determines the degree of similarity between the query created by the query creation unit 11 and each of the plurality of queries stored in the query storage unit 15. Then, the integration unit 14 integrates a query with a highest degree of similarity among a plurality of determination results with the query created by the query creation unit 11. Then, the query with the highest degree of similarity, stored in the query storage unit 15, may be rewritten using the query obtained by integration. Such an operation of the information processing apparatus according to the present example embodiment will be described below in detail.

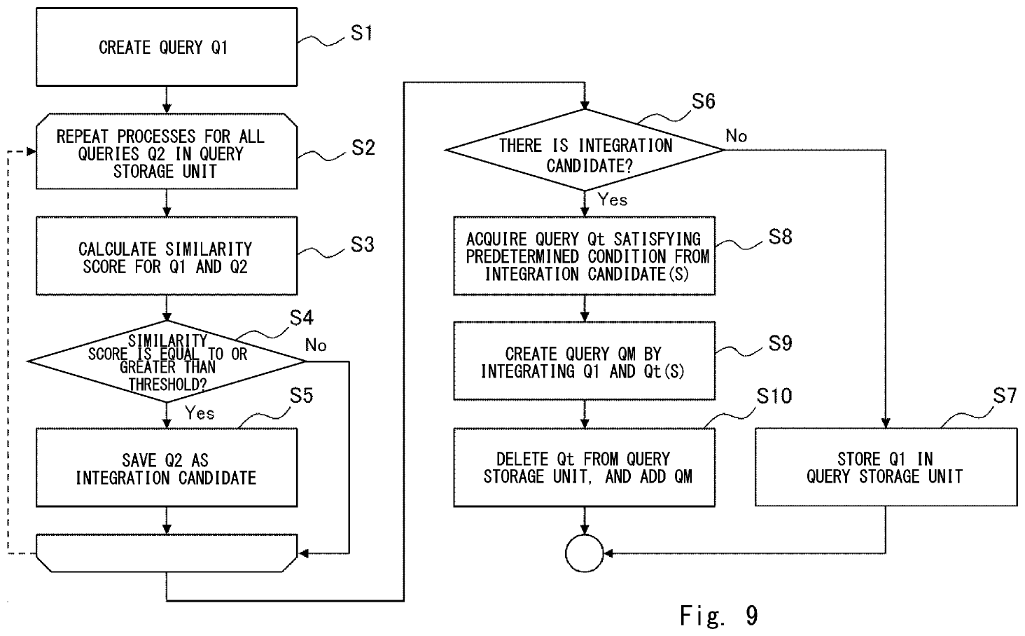

FIG. 9 is a flowchart for describing an example of an operation of the information processing apparatus according to the present example embodiment. As a prerequisite condition for the operation of the information processing apparatus described below, it is assumed that a plurality of queries Q2 are already stored in the query storage unit 15 shown in FIG. 2. Furthermore, a timing of creation of a new query Q1 by the query creation unit 11 (step S1 in FIG. 9) is taken as the trigger for the following operation.

When a new query Q1 is created by the query creation unit 11 (step S1), the information processing apparatus 10 repeatedly performs the following processes for all the queries Q2 that are stored in the query storage unit 15 (step S2).

That is, the similarity determination unit 13 calculates the similarity score for the query Q1 and the query Q2 (step S3). For example, the similarity determination unit 13 may calculate the similarity score for the query Q1 and the query Q2 by associating at least the nodes or the edges in the graph structure of the query Q1 with at least the nodes or the edges in the graph structure of the query Q2. Then, the similarity determination unit 13 determines whether the calculated similarity score is equal to or greater than a predetermined threshold (step S4). In the case where the calculated similarity score is equal to or greater than the predetermined threshold (step S4: Yes), the similarity determination unit 13 determines that the query Q1 and the query Q2 are similar to each other, and temporarily saves the Q2 in a memory as an integration candidate. On the other hand, in the case where the calculated similarity score is smaller than the predetermined threshold (step S4: No), the similarity determination unit 13 performs a similarity determination process (steps S2 to S5) on the next query Q2 that is stored in the query storage unit 15. Thereafter, such a similarity determination process is performed on all the queries Q2 that are stored in the query storage unit 15.

Then, if, as a result of performing the similarity determination process on all the queries Q2 that are stored in the query storage unit 15, there is no integration candidate (step S6: No), the query Q1 newly created by the query creation unit 11 is stored in the query storage unit 15 (step S7). A case where there is no integration candidate is a case where there is no query Q2 that is similar to the query Q1.

In the case where there is/are integration candidate(s) (step S6: Yes), a query Qt that satisfies a predetermined condition is acquired from the integration candidate(s) (step S8). A query that satisfies a predetermined condition here is a query for which the similarity score calculated in step S3 is the highest among the integration candidate(s), for example. Additionally, the predetermined condition is not limited to such a condition, and may be freely set by a user who uses the information processing apparatus 10.

Then, the integration unit 14 integrates the query Q1 and the query Qt, and creates the query QM (step S9). For example, the integration unit 14 may create the query QM after integration by extracting common parts between the graph structure corresponding to the query Q1 and the graph structure corresponding to the query Qt.

Then, the information processing apparatus 10 deletes the query Qt from the query storage unit 15, and adds the query QM obtained by integration to the query storage unit 15 (step S10). In other words, the information processing apparatus 10 rewrites the query Qt that is stored in the query storage unit 15 using the query QM obtained by integration.

In the present example embodiment, when a new query is created by the query creation unit 11, the new query is not stored in the query storage unit 15 as it is, and instead the number of queries to be stored in the query storage unit 15 is reduced by performing the processes as described above. That is, in the case where a query that is already stored in the query storage unit 15 and a newly created query are similar to each other, these queries are integrated. Then, the query that is stored in the query storage unit 15 is rewritten with the query obtained by integration. The number of queries to be stored in the query storage unit 15 may thus be reduced. Accordingly, an increase in the number of queries may be suppressed, and management of queries may be facilitated.

Next, details of the similarity determination by the similarity determination unit 13 will be given.

As described above, the similarity determination unit 13 calculates the similarity score for the query Q1 and the query Q2 by associating at least the nodes or the edges in the graph structure of the query Q1 with at least the nodes or the edges in the graph structure of the query Q2. Then, in the case where the similarity score is equal to or greater than the predetermined threshold, the query Q1 and the query Q2 are determined to be similar to each other. For example, the similarity determination unit 13 may calculate the similarity score using a method as described below.

First, a specificity score for the graph structure of the query Q1 (see FIG. 5) and a specificity score for the graph structure of the query Q2 (see FIG. 6) are calculated. For example, in the case where the number of sides (the number of edges) in a graph structure is taken as the specificity score, the number of edges in the graph structure of the query Q1 shown in FIG. 5 is 22 (including the three edges extending from the root node N1_0), and thus, the specificity score for the graph structure of the query Q1 is 22. Furthermore, the number of edges in the graph structure of the query Q2 shown in FIG. 6 is 19 (including the three edges extending from the root node N2_0), and thus, the specificity score for the graph structure of the query Q2 is 19.

Furthermore, the specificity score for the graph structure of the common parts between the graph structure of the query Q1 and the graph structure of the query Q2 (see FIG. 7; corresponding to the graph structure of the query QM) is calculated. The number of edges in the graph structure of the query QM shown in FIG. 7 is 15 (including the three edges extending from the root node NM_0), and thus, the specificity score for the graph structure of the query QM is 15.

Then, the similarity score is calculated using the specificity scores determined in the above manner. In the present example embodiment, the similarity score may be calculated by the following equation, for example.

$$Similarity score = ( specificity score for query QM \times 2 ) / ( specificity score for query Q 1 + specificity score for query Q 2 ) = ( 15 \times 2 ) / ( 22 + 19 ) \approx 0.73$$

From the equation above, the similarity score for the query Q1 and the query Q2 is about 0.73.

Additionally, the calculation method for the similarity score described above is merely an example, and in the present example embodiment, the similarity score may also be calculated using methods other than the method described above. For example, in the example described above, a case is described where the number of sides (the number of edges) in the graph structure is taken as the specificity score, but the nodes may be used instead for calculation of the specificity score. Alternatively, both the nodes and the edges may be used for calculation of the specificity score. Moreover, the specificity score may be calculated by weighting the nodes and the edges.

Furthermore, in the present example embodiment, the similarity determination unit 13 may calculate the specificity score by solving an optimization problem related to an association between each of the nodes and the edges in the graph structure of the query Q1 and each of the nodes and the edges in the graph structure of the query Q2.

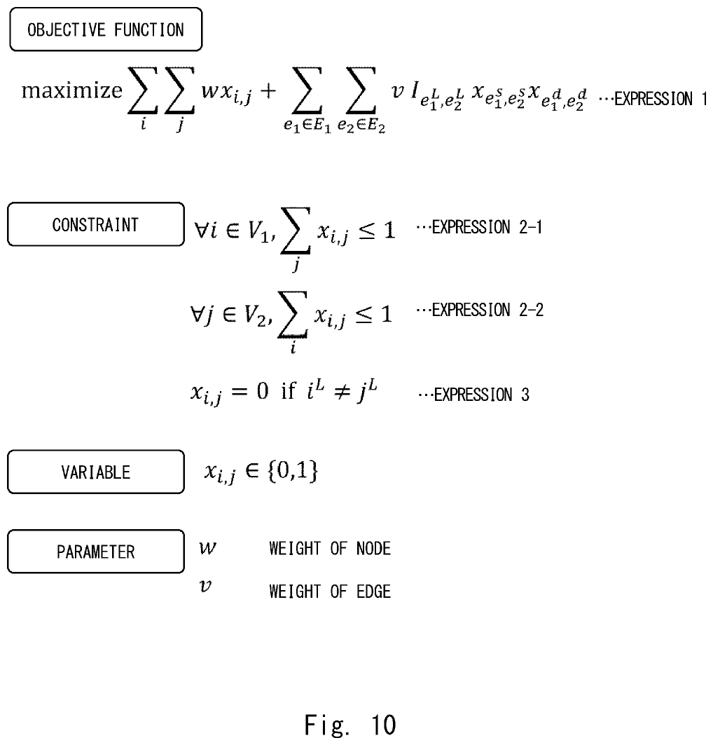

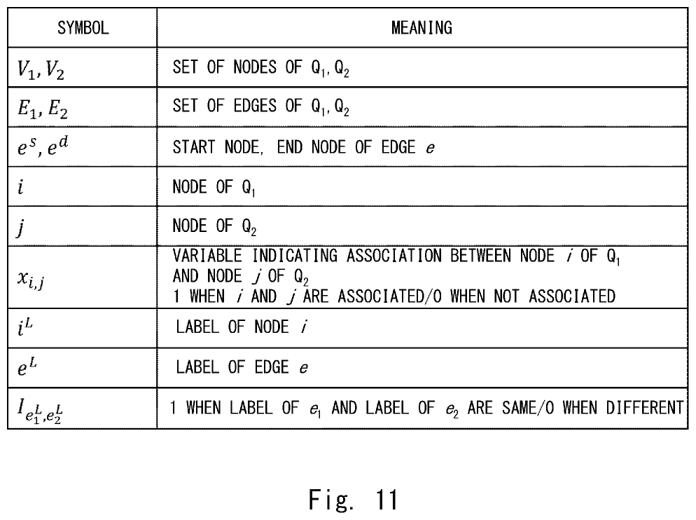

FIGS. 10 and 11 are diagrams for describing an example of the calculation method for the similarity score. FIG. 10 shows each of an objective function, a constraint, a variable, and a parameter. FIG. 11 shows a description of symbols used in FIG. 10.

With respect to the object function indicated by Expression 1 in FIG. 10, a first term is a term related to a correspondence between nodes, or in other words, a term related to a correspondence between a node in the graph structure of the query Q1 and a node in the graph structure of the query Q2. Furthermore, a second term is a term related to a correspondence between edges, or in other words, a term related to a correspondence between an edge in the graph structure of the query Q1 and an edge in the graph structure of the query Q2.

In Expression 1, i refers to the node of the query Q1, and j refers to the node of the query Q2. Furthermore, w is a weight of the node, and x_{i,j} is a variable indicating a correspondence between the node i of the query Q1 and the node j of the query Q2, and is “1” when i and j correspond to each other and “0” when the two do not correspond to each other. Furthermore, in the second term of Expression 1, v is a weight of the edge. Furthermore, Ie₁^{L}, e₂^{L} is “1” when the label of e₁ and the label of e₂ are the same, and is “0” when the two are different. A source node and a target node of an edge e are indicated by e^{s} and e^{d}, respectively.

Expression 2-1 and Expression 2-2 are constraint conditions indicating that one node does not correspond to two or more nodes. Expression 3 is a constraint condition indicating that an association is made between nodes with matching labels.

Accordingly, in the first term of Expression 1, a value is added when the labels of i and j match (when the nodes match). Furthermore, in the second term of Expression 1, a value is added when the label of eᵢ and the label of e₂ are the same. Accordingly, with Expression 1, the value of Expression is greater, the greater the number of matching nodes and edges between the graph structure of the query Q1 and the graph structure of the query Q2. That is, in the case where the value of Expression 1 is used as the specificity score, the specificity score is higher, the greater the similarity between the graph structure of the query Q1 and the graph structure of the query Q2. The specificity score determined at this time corresponds to the specificity score for the query QM (see FIG. 7).

To calculate the similarity score, the specificity score for the graph structure of the query Q1 (see FIG. 5) and the specificity score for the graph structure of the query Q2 (see FIG. 6) are further calculated. For example, the specificity score for the query Q1 may be calculated by calculating a weighted sum for the nodes and the edges in the graph structure of the query Q1 shown in FIG. 5, by using the weight w of the node and the weight v of the edge indicated by the parameter in FIG. 10. In the same manner, the specificity score for the query Q2 may be calculated by calculating a weighted sum for the nodes and the edges in the graph structure of the query Q2 shown in FIG. 6, by using the weight w of the node and the weight v of the edge indicated by the parameter in FIG. 10.

Then, the similarity score is calculated using the specificity score for the query Q1, the specificity score for the query Q2, and the specificity score for the query QM determined in the above manner. As described above, in the present example embodiment, the similarity score may be calculated using the following equation, for example.

$$Similarity score = ( specificity score for query QM \times 2 ) / ( specificity score for query Q 1 + specificity score for query Q 2 )$$

The similarity determination unit 13 determines that the query Q1 and the query Q2 are similar to each other, in the case where the similarity score is equal to or greater than the predetermined threshold.

The similarity determination unit 13 may determine the degree of similarity between the query Q1 and the query Q2 by using the method described above.

The integration unit 14 creates the query QM using the sub-graph structure common with the query Q2 (see FIG. 7) satisfying a predetermined condition, among queries for which similarity determination is performed in relation to the query Q1. For example, the predetermined condition here is that (1) the similarity score calculated using the specificity scores is the greatest, or that (2) the similarity score calculated by solving the optimization problem for the objective function is the greatest.

Additionally, as described above, at the time of performing similarity determination by the similarity determination unit 13, similarity determination is sometimes performed using the graph structure (see FIG. 7) of common parts between the graph structure of the query Q1 and the graph structure of the query Q2. In such a case, the integration unit 14 may perform the integration process by using the graph structure of the common parts (see FIG. 7) created by the similarity determination unit 13. In the case of calculating the specificity score by using the optimization problem indicated in FIG. 10, the common sub-graph structure may be extracted based on an association between nodes indicated by x_{i,j} that maximizes the objective function.

Next, another example configuration of the information processing apparatus according to the present example embodiment will be described.

With the information processing apparatus 10 described above, the integration unit 14 integrates the query Q1 and the query Q2 by extracting the common parts between the graph structure corresponding to the query Q1 and the graph structure corresponding to the query Q2. In the integration process described above, in the case where the label of a node of the query Q1 and the label of a node of the query Q2 are different, these nodes are assumed to be parts that are not common and a process is performed to delete these nodes.

However, when such an integration process is performed, conditions of the query obtained by integration are possibly unnecessarily relaxed. That is, queries are partially deleted due to integration of the queries, but when the number of nodes that are deleted at this time is great, search accuracy of the query is possibly reduced due to the conditions of the query becoming too relaxed.

To solve such a problem, another example configuration of the information processing apparatus according to the present example embodiment allows the node of the query obtained by integration to hold a set of labels. Specifically, in the case where a label L1 of a specific node in the graph structure of the query Q1 and a label L2 of a specific node in the graph structure of the query Q2 are compatible, the integration unit 14 includes the label L1 and the label L2 in the specific node of the query after integration. In the following, this other example configuration of the information processing apparatus according to the present example embodiment will be described in detail.

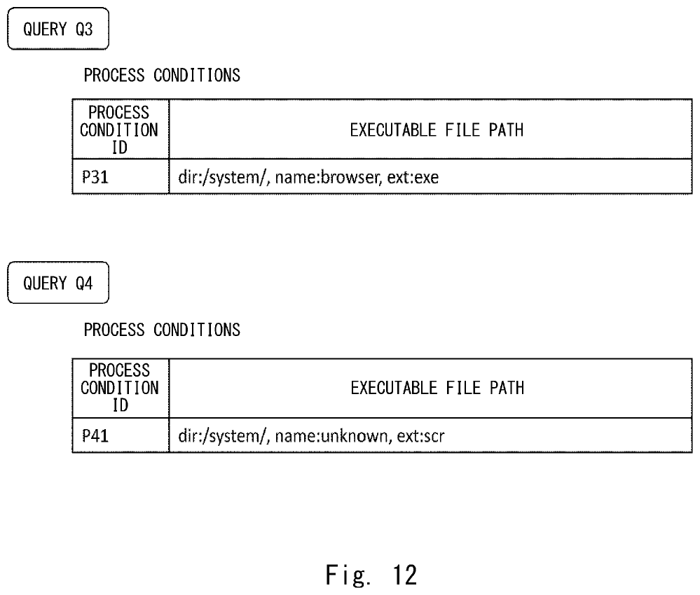

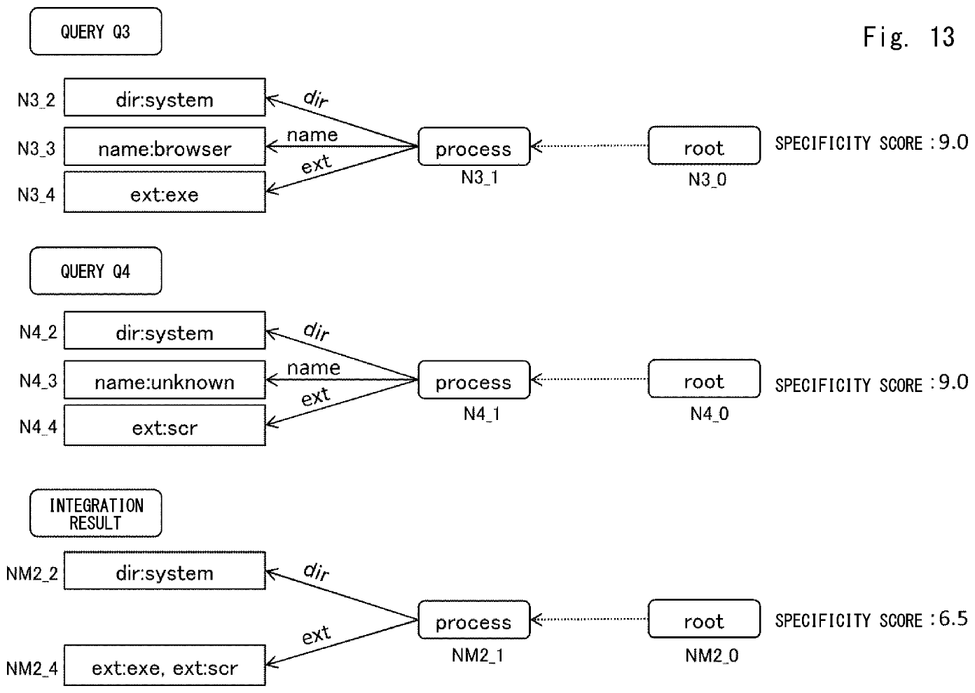

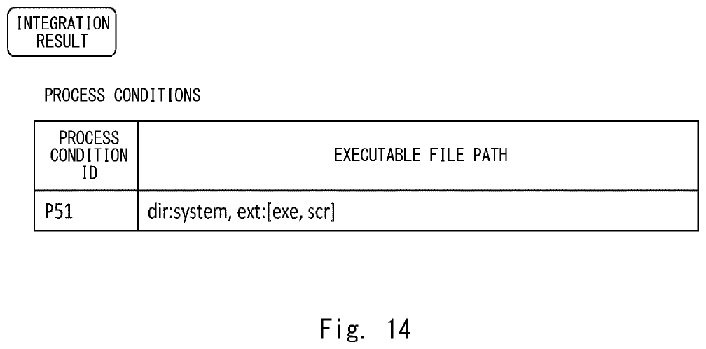

FIGS. 12 to 15 are diagrams for describing the other example configuration of the information processing apparatus according to the present example embodiment. FIG. 12 shows tables each indicating an example of a query Q3, Q4, FIG. 13 is a diagram for describing another example of the integration process, and FIG. 14 is a table showing the query QM obtained by integration. Additionally, with respect to the queries Q3 and Q4, only parts of the queries are shown. Furthermore, compatibility/incompatibility may be freely defined according to the meaning of the node. In the following description, it is assumed that “name:browser” and “name:unknown” are defined in advance to be incompatible, and that “ext:exe” and “ext:scr” are defined in advance to be compatible, for example.

As shown in FIG. 12, with respect to the process conditions for the query Q3, the process condition ID is “P31”, and the executable file path is {dir:system, name:browser, ext:exe}. Furthermore, with respect to the process conditions for the query Q4, the process condition ID is “P41”, and the executable file path is {din system, name:unknown, ext:scr}.

Such queries Q3 and Q4 are expressed as graph structures as shown in FIG. 13.

In the graph structure of the query Q3 shown in FIG. 13, a node N3_1 corresponds to a node, of the query Q3 shown in FIG. 12, whose process condition ID is “P31”. Furthermore, nodes N3_2, N3_3, and N3_4 correspond, respectively, to the executable file paths “dir:system”, “name:browser”, and “ext:exe” associated with the process condition ID “P31” of the query Q3 in FIG. 12. Arrows extending from the node N3_1 to the nodes N3_2, N3_3, and N3_4 each indicate an edge, and labels of the edges are “dir”, “name”, and “ext”, respectively. A node N3_0 is a root node.

In the graph structure of the query Q4 shown in FIG. 13, a node N4_1 corresponds to a node, of the query Q4 shown in FIG. 12, whose process condition ID is “P41”. Furthermore, nodes N4_2, N4_3, and N4_4 correspond, respectively, to the executable file paths “dir:system”, “name:unknown”, and “ext:scr” associated with the process condition ID “P41” of the query Q4 in FIG. 12. Arrows extending from the node N4_1 to the nodes N4_2, N4_3, and N4_4 each indicate an edge, and labels of the edges are “dir”, “name”, and “ext”, respectively. A node N4_0 is a root node.

An integration result in FIG. 13 is a graph structure indicating an integration result for the query Q3 and the query Q4.

In the graph structure indicated by the integration result in FIG. 13, a node NM2_1 corresponds to the node N3_1 in the graph structure of the query Q3, and to the node N4_1 in the graph structure of the query Q4. In the graph structure indicated by the integration result in FIG. 13, a node NM2_2 corresponds to the node N3_2 in the graph structure of the query Q3, and to the node N4_2 in the graph structure of the query Q4. That is, the label of the node N3_2 in the graph structure of the query Q3 is “dir:system”, and the label of the node N4_2 in the graph structure of the query Q4 is “dir:system”, and because these are a same label, these nodes are shown as the node NM2_2 in the graph structure indicated by the integration result.

In contrast, the label of the node N3_3 in the graph structure of the query Q3 is “name:browser”, and the label of the node N4_3 in the graph structure of the query Q4 is “name:unknown”, and these labels are different. Furthermore, because there is no compatibility between these labels, corresponding nodes are deleted from the graph structure indicated by the integration result.

Furthermore, the label of the node N3_4 in the graph structure of the query Q3 is “ext:exe”, and the label of the node N4_4 in the graph structure of the query Q4 is “ext:scr”, and these labels are different. However, these labels are compatible (are defined to be compatible) with each other, and thus, these nodes are shown as a node NM2_4 in the graph structure indicated by the integration result. At this time, a union of the two labels (ext:exe, ext:scr) is included in the node NM2_4 as the label, and these are taken as an OR condition at the time of search.

When expressed as a query, the graph structure of the integration result shown in FIG. 13 is as indicated by a table shown in FIG. 14. In the query shown in FIG. 14, the process ID is “P51”, and the executable file path is {dir:system, ext: [exe, scr] }.

As described above, with the other example configuration of the present example embodiment, in relation to graph structures corresponding to respective queries, even in a case where the labels of nodes corresponding to each other are different, if there is compatibility between the labels, the corresponding node takes a union of the labels. The union is treated as an OR condition at the time of search, and thus, reduction in the search accuracy of the query due to the conditions of the query being too relaxed may be prevented.

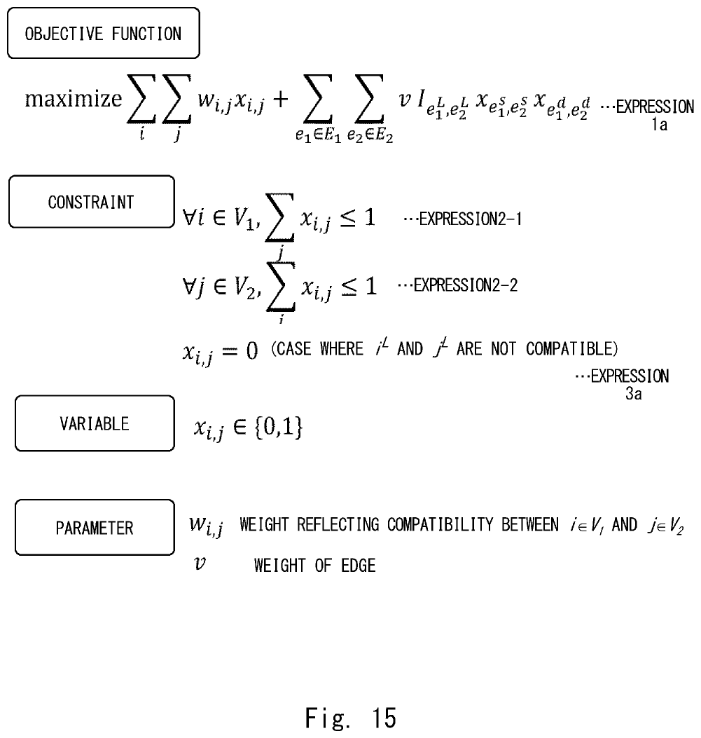

FIG. 15 is a diagram for describing an example of the calculation method for the similarity score according to the other example configuration of the present example embodiment. The expressions shown in FIG. 15 correspond to the expressions shown in FIG. 10. In FIG. 15, Expressions 1a and 3a are different from Expressions 1 and 3 shown in FIG. 10. Furthermore, a parameter w_{i,j} in FIG. 15 is different from the parameter w (the weight of the node) shown in FIG. 10.

In FIG. 15, as indicated by Expression 3a, in the case where there is no compatibility between a label i^{L} of a node i (a node Q1) and a label j^{L} of a node j (a node Q2), (x_{i,j}=0) is established such that an association is not made between the nodes. Furthermore, at the time of determining the weight parameter w_{i,j}, the weight is to reflect the compatibility between the node i (the node Q1) and the node j (the node Q2). Other aspects are the same as in the case shown in FIG. 10.

In the following, an example of a calculation method for the weight of the node will be described.

For example, the specificity score may be calculated by using the following weight in relation to a label set L of a node. That is, in the case where “incompatible labels” are included in the label set L, the node weight is zero. In contrast, in the case where “incompatible labels” are not included in the label set, the node weight is an inverse number of the number of elements in the label set L.

Specifically, in the case where there are label sets Li and Lj for i and j, LU is taken as a union of Li and Lj. Then, in the case where “incompatible labels” are included in LU, the node weight is made zero. For example, w_{i,j}=0 is established in the case where it is set (defined), with respect to Li={“name:malware”} and Lj={“name:browser”}, that “name:malware” and “name:browser” are incompatible.

In contrast, in the case where “incompatible labels” are not included in LU, the node weight is the inverse number of the number of elements in LU. For example, in the case where it is defined, with respect to Li={“ext:exe”, “ext:scr”} and Lj={“ext:scr”, “ext:dll”}, that “ext:exe”, “ext:scr”, and “ext:dll” are compatible, the size of LU={“ext:exe”, “ext:scr”, “extdll”} is three, and the node weight is w_{i,j}=⅓.

For example, in the case where the number of elements in the label set L is five, the node weight is “⅕”. That is, the node weight becomes smaller as the number of elements in the label set L becomes greater. This is because the number of labels (set of labels in a union) included in a node becomes greater as the number of elements in the label set L becomes greater, thereby causing the node weight (importance) to be reduced.

An example of the calculation method for the specificity score will be specifically described with reference to FIG. 13. In FIG. 13, the weight of each edge is given as “1”. Furthermore, in the case where the number of labels of a node is “1”, the weight of the node is given as “1”. For example, with respect to the query Q3, the number of nodes is five (the root node included), and the number of edges is four, and thus, the specificity score is “9.0”. Furthermore, with respect to the query Q4, the number of nodes is five (the root node included), and the number of edges is four, and thus, the specificity score is “9.0”.

According to the integration result, the number of nodes for which the number of labels is “1” is three, and the number of edges is three. Furthermore, the number of nodes for which the number of labels is “2” is one (NM2_4). Here, the specificity score for the node (NM2_4) is “½”, and thus, the specificity score for the integration result is “6.5”.

Next, an information processing system including the information processing apparatus according to the present example embodiment will be described. FIG. 16 is a block diagram for describing the information processing system including the information processing apparatus according to the present example embodiment.

As shown in FIG. 16, an information processing system 100 according to the present example embodiment includes a search apparatus 20, in addition to the information processing apparatus 10 described above. A terminal 25 is connected to the search apparatus 20, and event information of the terminal 25 is supplied from the terminal 25 to the search apparatus 20. The terminal 25 is a terminal as a target for which threat hunting is performed (that is, a malware inspection target). There may be a plurality of terminals 25. For example, the terminals 25 are a plurality of computers connected to a network.

A query is supplied to the search apparatus 20 from the query storage unit 15 of the information processing apparatus 10. The search apparatus 20 may identify a terminal where malware is operating, by searching for event information that matches the query supplied from the information processing apparatus 10 (the query storage unit 15) from pieces of event information collected from the terminals 25.

As shown in FIG. 16, the search apparatus 20 includes an event information storage unit 21 and a search unit 22. The event information storage unit 21 stores the event information collected from the terminal 25. For example, the event information storage unit 21 may store pieces of event information collected from a plurality of terminals 25, in association with respective terminals 25 (that is, in association with respective terminal IDs).

The search unit 22 searches for the event information that matches the query from the pieces of event information stored in the event information storage unit 21, by using the query supplied from the information processing apparatus 10 (the query storage unit 15). The search unit 22 may thus identify the terminal that matches the query from the plurality of terminals 25. The search apparatus 20 may thus identify a terminal that exhibits a specific behavior (that is, a terminal where malware is possibly operating).

In the example embodiment described above, a hardware configuration is described as the present invention, but the present invention is not limited thereto. The present invention may also allow information processing described above to be implemented by causing a central processing unit (CPU) as a processor to execute a computer program.

That is, a process of determining the degree of similarity between first and second queries used for detection of behavior of malware, and a process of integrating the first and second queries according to the determination result are performed. Then, at the time of determining the degree of similarity, the degree of similarity between the first and second queries is determined by using a first graph structure corresponding to the first query and a second graph structure corresponding to the second query. Furthermore, at the time of integrating the first and second queries, the first and second queries are integrated by extracting common parts between the first graph structure and the second graph structure. A computer may be caused to execute a program for executing such processes.

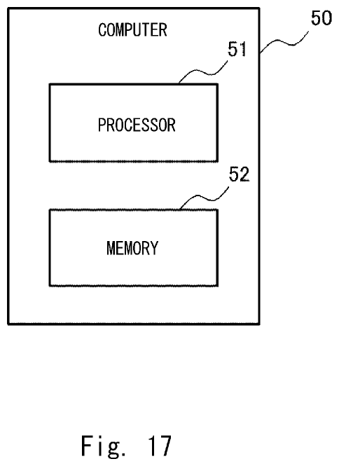

FIG. 17 is a block diagram showing a computer for executing an information processing program according to the present invention. As shown in FIG. 17, a computer 50 includes a processor 51 and a memory 52. The information processing program according to the present invention is stored in the memory 52. The processor 51 reads the information processing program from the memory 52. Information processing according to the present invention described above may be executed by the processor 51 executing the information processing program.

The program described above may be supplied to a computer by being stored in various types of non-transitory computer-readable media. The non-transitory computer-readable media include various types of tangible recording media (tangible storage media). Examples of the non-transitory computer-readable media include a magnetic recording medium (such as a flexible disk, a magnetic tape, and a hard disk drive), a magneto-optical recording medium (such as a magneto-optical disk), a CD-ROM (read only memory) CD-R, a CD-R/W, a semiconductor memory (such as a mask ROM, a programmable ROM (PROM), an erasable PROM (EPROM), a flash ROM, and a random access memory (RAM)). The program may also be supplied to a computer by various types of transitory computer-readable media. Examples of the transitory computer-readable media include an electrical signal, an optical signal, and an electromagnetic wave. The transitory computer-readable medium may supply the program to a computer through a wired communication channel such as an electrical wire or an optical fiber, or a wireless communication channel.

The example embodiment described above may also be partially or entirely described by Supplementary notes below, but is not limited thereto.

### (Supplementary Note 1)

An information processing apparatus comprising:

a similarity determination unit configured to determine a degree of similarity between first and second queries used for detection of behavior of malware; and

an integration unit configured to perform integration of the first and second queries according to a determination result from the similarity determination unit, wherein

the similarity determination unit determines the degree of similarity between the first and second queries by using a first graph structure corresponding to the first query and a second graph structure corresponding to the second query, and

the integration unit performs integration of the first and second queries by extracting a common part between the first graph structure and the second graph structure.

### (Supplementary Note 2)

The information processing apparatus according to Supplementary note 1, further comprising a graph structure creation unit configured to create the first and second graph structures by expressing each of the first and second queries as a directed graph.

### (Supplementary Note 3)

The information processing apparatus according to Supplementary note 1 or 2, wherein the similarity determination unit

calculates a similarity score for the first and second queries by associating at least one of a node and an edge in the first graph structure with at least one of a node and an edge in the second graph structure, and

determines that the first and second queries are similar to each other, in a case where the similarity score is equal to or greater than a predetermined threshold.

### (Supplementary Note 4)

The information processing apparatus according to Supplementary note 3, wherein the similarity determination unit calculates the similarity score by solving an optimization problem related to an association between each of the node and the edge in the first graph structure and each of the node and the edge in the second graph structure.

### (Supplementary Note 5)

The information processing apparatus according to any one of Supplementary notes 1 to 4, further comprising a query creation unit to which a dynamic analysis result is supplied from a dynamic analysis apparatus configured to dynamically analyze behavior of malware, the query creation unit being configured to create a query using the dynamic analysis result that is supplied.

(Supplementary note 6)

The information processing apparatus according to Supplementary note 5, further comprising a query storage unit configured to store the query, wherein

the similarity determination unit determines the degree of similarity between the first query supplied from the query creation unit and the second query supplied from the query storage unit, and

the integration unit performs integration of the first and second queries and rewrites the second query stored in the query storage unit with a query obtained by the integration, in a case where the first and second queries are determined to be similar to each other.

(Supplementary note 7)

The information processing apparatus according to Supplementary note 5, further comprising a query storage unit configured to store the query, wherein

a plurality of queries are stored in the query storage unit, each as the second query,

the similarity determination unit determines the degree of similarity between the first query supplied from the query creation unit and each of the second queries supplied from the query storage unit, and

the integration unit performs integration of a second query for which the degree of similarity is highest, among the second queries, with the first query, and rewrites the second query for which the degree of similarity is highest and that is stored in the query storage unit, by using a query obtained by the integration.

### (Supplementary Note 8)

The information processing apparatus according to any one of Supplementary notes 1 to 7, wherein, in a case where a first label of a specific node in the first graph structure and a second label of a specific node in the second graph structure are compatible with each other, the integration unit includes the first label and the second label in the specific node of a query obtained by the integration.

### (Supplementary Note 9)

An information processing system comprising:

the information processing apparatus according to any one of Supplementary notes 1 to 8; and

a search apparatus configured to search for event information that matches a query that is supplied from the information processing apparatus, from event information collected from a terminal.

### (Supplementary Note 10)

The information processing system according to Supplementary note 9, wherein the search apparatus includes

an event information storage unit configured to store pieces of event information collected from a plurality of terminals, in association with respective terminals, and

a search unit configured to search for event information that matches a query supplied from the information processing apparatus, from the pieces of event information stored in the event information storage unit, and to identify a terminal that matches the query from the plurality of terminals.

### (Supplementary Note 11)

An information processing method comprising:

determining a degree of similarity between first and second queries used for detection of behavior of malware;

integrating the first and second queries according to a result of the determining;

determining the degree of similarity between the first and second queries by using a first graph structure corresponding to the first query and a second graph structure corresponding to the second query, at a time of determining the degree of similarity; and

integrating the first and second queries by extracting a common part between the first graph structure and the second graph structure, at a time of integrating the first and second queries.

### (Supplementary Note 12)

A non-transitory computer-readable medium storing a program for causing a computer to perform processes including

determining a degree of similarity between first and second queries used for detection of behavior of malware,

integrating the first and second queries according to a result of the determining,

determining the degree of similarity between the first and second queries by using a first graph structure corresponding to the first query and a second graph structure corresponding to the second query, at a time of determining the degree of similarity, and

integrating the first and second queries by extracting a common part between the first graph structure and the second graph structure, at a time of integrating the first and second queries.

Heretofore, the present invention has been described with reference to the example embodiment, but the present invention is not limited to the configuration of the example embodiment above, and is, of course, open to various modifications, corrections and combinations that may occur to a person skilled in the art within the scope of the invention as described in the claims of the present patent application.

### REFERENCE SIGNS LIST

10 INFORMATION PROCESSING APPARATUS
11 QUERY CREATION UNIT
12 GRAPH STRUCTURE CREATION UNIT
13 SIMILARITY DETERMINATION UNIT
14 INTEGRATION UNIT
15 QUERY STORAGE UNIT
18 DYNAMIC ANALYSIS APPARATUS
20 SEARCH APPARATUS
21 EVENT INFORMATION STORAGE UNIT
22 SEARCH UNIT
25 TERMINAL
50 COMPUTER
51 PROCESSOR
52 MEMORY
100 INFORMATION PROCESSING SYSTEM

What is claimed is:

1. An information processing apparatus comprising:
a similarity determination unit configured to determine a degree of similarity between first and second queries used for detection of behavior of malware; and
an integration unit configured to perform integration of the first and second queries according to a determination result from the similarity determination unit, wherein
the similarity determination unit determines the degree of similarity between the first and second queries by using a first graph structure corresponding to the first query and a second graph structure corresponding to the second query, and
the integration unit performs integration of the first and second queries by extracting a common part between the first graph structure and the second graph structure.

2. The information processing apparatus according to claim 1, further comprising a graph structure creation unit configured to create the first and second graph structures by expressing each of the first and second queries as a directed graph.

3. The information processing apparatus according to claim 1, wherein the similarity determination unit
calculates a similarity score for the first and second queries by associating at least one of a node and an edge in the first graph structure with at least one of a node and an edge in the second graph structure, and
determines that the first and second queries are similar to each other, in a case where the similarity score is equal to or greater than a predetermined threshold.

4. The information processing apparatus according to claim 3, wherein the similarity determination unit calculates the similarity score by solving an optimization problem related to an association between each of the node and the edge in the first graph structure and each of the node and the edge in the second graph structure.

5. The information processing apparatus according to claim 1, further comprising a query creation unit to which a dynamic analysis result is supplied from a dynamic analysis apparatus configured to dynamically analyze behavior of malware, the query creation unit being configured to create a query using the dynamic analysis result that is supplied.

6. The information processing apparatus according to claim 5, further comprising a query storage unit configured to store the query, wherein
the similarity determination unit determines the degree of similarity between the first query supplied from the query creation unit and the second query supplied from the query storage unit, and
the integration unit performs integration of the first and second queries and rewrites the second query stored in the query storage unit with a query obtained by the integration, in a case where the first and second queries are determined to be similar to each other.

7. The information processing apparatus according to claim 5, further comprising a query storage unit configured to store the query, wherein
a plurality of queries are stored in the query storage unit, each as the second query,
the similarity determination unit determines the degree of similarity between the first query supplied from the query creation unit and each of the second queries supplied from the query storage unit, and
the integration unit performs integration of a second query for which the degree of similarity is highest, among the second queries, with the first query, and rewrites the second query for which the degree of similarity is highest and that is stored in the query storage unit, by using a query obtained by the integration.

8. The information processing apparatus according to claim 1, wherein, in a case where a first label of a specific node in the first graph structure and a second label of a specific node in the second graph structure are compatible with each other, the integration unit includes the first label and the second label in the specific node of a query obtained by the integration.

9. An information processing system comprising:
the information processing apparatus according to claim 1; and
a search apparatus configured to search for event information that matches a query that is supplied from the information processing apparatus, from event information collected from a terminal.

10. The information processing system according to claim 9, wherein the search apparatus includes
an event information storage unit configured to store pieces of event information collected from a plurality of terminals, in association with respective terminals, and
a search unit configured to search for event information that matches a query supplied from the information processing apparatus, from the pieces of event information stored in the event information storage unit, and to identify a terminal that matches the query from the plurality of terminals.

11. An information processing method comprising:
determining a degree of similarity between first and second queries used for detection of behavior of malware;
integrating the first and second queries according to a result of the determining;
determining the degree of similarity between the first and second queries by using a first graph structure corresponding to the first query and a second graph structure corresponding to the second query, at a time of determining the degree of similarity; and
integrating the first and second queries by extracting a common part between the first graph structure and the second graph structure, at a time of integrating the first and second queries.

12. A non-transitory computer-readable medium storing a program for causing a computer to perform processes including
determining a degree of similarity between first and second queries used for detection of behavior of malware,
integrating the first and second queries according to a result of the determining,
determining the degree of similarity between the first and second queries by using a first graph structure corresponding to the first query and a second graph structure corresponding to the second query, at a time of determining the degree of similarity, and
integrating the first and second queries by extracting a common part between the first graph structure and the second graph structure, at a time of integrating the first and second queries.
